(19) United States
(12) Patent Application Publication
(10) Pub. No.: US 2008/0119258 A1
(43) Pub. Date: May 22, 2008

(54) GAMING TICKET COMPRISING VALIDATION DATA, SECURITY METHOD AND OPTICAL READER FOR SUCH A GAMING TICKET

(75) Inventors: Frederic Perez, Asnieres Sur Seine (FR); Remi Theys, Puyricard (FR)

Correspondence Address: Young & Thompson, 745 S. 23rd Street., Second Floor, Arlington, VA, 22202, US

(73) Assignee: LA FRANCAISE DES JEUX, Boulogne Billancourt (FR)

(21) Appl. No.: 11/936,851

(22) Filed: Nov. 8, 2007

(30) Foreign Application Priority Data
Nov. 21, 2006 (FR) 06 10193

(51) Int. Cl. G06F 19/00

(52) U.S. Cl. 463/17; 235/462.25; 463/29

(57) ABSTRACT

The invention relates to a gaming ticket (10) comprising validation data which are printed on a face (12) thereof and which are covered with at least one layer of ink which is opaque with respect to visible light. The at least one layer of ink is at least partially transparent with respect to light having a wavelength different from that of visible light.

### TECHNICAL FIELD

The present invention relates to the field of securing validation data printed on a gaming ticket, and in particular an instant-win lottery ticket. The invention also relates to a method for securing the validation data and an optical reader for a gaming ticket.

### BACKGROUND TO THE INVENTION

The validation data of a gaming ticket, for example, in the form of a bar code, constitute the validation code identifying each ticket in a unique manner. Those data need to be accessible at any time, for example, for matters of commercialisation and payment of the prizes. Such data also have to be secured in order to prevent occurrences of fraud, in particular the complete or partial duplication of the gaming ticket which would allow the fraudulent person to have the prize associated with the ticket paid over to him several times.

A number of techniques for securing the validation data have been developed, such as, for example, the concealment of the data in patterns which are non-significant but which are very similar to the one used for the data, such as, for example, impressionist markings, or printing data with inks of a colour having a weak contrast with respect to those used for the base region on which they are printed.

Each of those techniques has the disadvantage that the validation data are directly accessible to anyone. Thus, a fraudulent person provided with a common, commercially available piece of equipment, such as, for example, a good-quality scanner, is in a position to acquire the impression region of the data and, from that point, to establish those validation data.

### SUMMARY OF THE INVENTION

The object of the present invention is to solve the above-mentioned problem by providing an effective means for securing the validation data, preventing direct access to the validation data.

To that end, the invention relates to a gaming ticket comprising validation data which are printed on a face thereof and which are covered with at least one layer of ink which is opaque with respect to visible light, wherein the at least one layer of ink is at least partially transparent with respect to light having a wavelength different from that of visible light.

In this manner, the validation data cannot be read either by a human being or by pieces of standard reproduction or digitisation equipment which are sensitive only to visible light because the data are covered by a layer which is opaque with respect to that light.

According to other features, the gaming ticket comprises one or more of the following features:

the at least one layer of ink is at least partially transparent with respect to light of infrared wavelength;

the validation data are integrated in a removable film;

the validation data are printed on a removable layer of ink of the face of the ticket, and the at least one layer of ink which is opaque with respect to visible light can be removed.

The invention also relates to an optical reader for a gaming ticket; comprising means for capturing validation data which are printed on a face of a gaming ticket, wherein it comprises means for illuminating the face with light having a wavelength different from that of visible light in such a manner as to cause validation data, which are printed on the face and which are covered with a mask of ink which is at least partially transparent with respect to the light, to appear, and in that the capturing means are able to acquire the validation data under such light.

According to another feature of the optical reader, the illumination means emit light of infrared wavelength.

The invention also relates to a method for securing validation data of a gaming ticket, comprising a step for printing the validation data on a face of the gaming ticket, wherein it comprises a step for printing, on the validation data, at least one layer of ink which is opaque with respect to visible light and which is at least partially transparent with respect to light having a wavelength different from that of visible light.

According to another feature, the method for reading validation data of a gaming ticket as defined above is wherein the step for printing the validation data comprises:

a step for printing a first removable layer on the face of the gaming ticket; and

a step for printing the validation data on the first removable layer,

and in that the at least one layer of ink which is opaque with respect to visible light can be removed.

The invention also relates to a method for reading validation data from a gaming ticket acquired in accordance with the above-mentioned method, wherein it comprises, at the same time as a step for capturing the validation data, a step for illuminating the face of the ticket with a light having a wavelength at which the at least one layer of ink is at least partially transparent.

### BRIEF DESCRIPTION OF THE DRAWINGS

The invention will be better understood from a reading of the following description, given purely by way of example and with reference to the appended drawings, in which:

FIG. 1 is a top view of a gaming ticket according to the first embodiment of the invention, illuminated by visible light;

FIG. 2 is the same ticket, but illuminated with infrared light; and

FIG. 3 illustrates steps for producing a region of secured data in accordance with a second embodiment of the invention.

### DESCRIPTION OF PREFERRED EMBODIMENTS

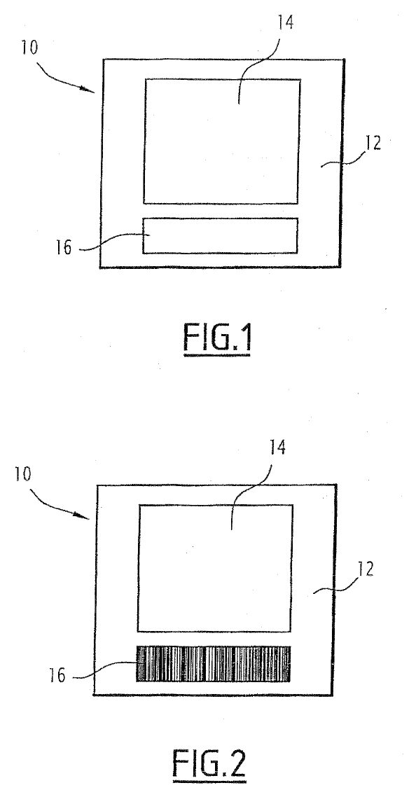

In FIG. 1, an instant-win gaming ticket 10 in accordance with a first embodiment comprises, on a cardboard face 12 thereof, a gaming region 14 and a secured data region 16.

FIG. 1 illustrates the situation in which the ticket is illuminated with visible light, for example, daylight, conventionally defined as a light having a wavelength of between approximately 400 nanometres and 800 nanometres. The secured data region 16 is in the form of a monochrome or polychrome mask which is opaque with respect to visible light and which allows none of the data which are printed below it to show through.

It should be noted that the term “opaque” refers in this instance to the fact that a human eye or a reading device, for example, a scanner type device which is sensitive to visible light, cannot discern what is present under that mask.

Naturally, the mask could be slightly transparent with respect to visible light, whilst remaining opaque in the context of the invention.

The secured data region 16 comprises validation data, for example, of the bar code type, which are printed on the face 12, preferably in black ink by means of an ink jet printing technique. The region 16 also comprises one or more layers of ink, which may or may not be removable and which is/are printed on the validation data in order to form the mask which is opaque with respect to visible light.

The ink of the mask is selected so as to be opaque with respect to visible light, but also to be transparent or semi-transparent with respect to a light outside the visible domain, and preferably transparent or semi-transparent with respect to light having an infrared wavelength greater than 800 nanometres.

For example, for the infrared domain, inks of the primary colours blue/cyan, red/magenta or yellow, or any combination thereof, can be used.

The infrared domain is particularly suitable for securing the data.

Since the human eye is not sensitive to infrared rays, a human being cannot read by himself data which are hidden under the layer of ink, even if the gaming ticket is illuminated by infrared light. Even under those illumination conditions, the layer of ink still appears to be opaque to humans.

Thus, only an optical reader according to the invention described hereinafter, is capable of reading the validation data.

By way of a variant, other wavelength domains can be selected such as, for example, the ultraviolet domain (UV).

However, such a domain has the disadvantage of making validation data visible to the human eye when the ticket is illuminated by an ultraviolet source.

FIG. 2 illustrates the ticket of FIG. 1 when it is illuminated by an infrared light. In this configuration, the mask of the secured data region 16 becomes indistinct and allows the validation data to show through, in this instance in the form of a bar code.

According to the invention, there is also provided an optical reader which is intended to read and process the validation data of a ticket according to the invention.

Such an optical reader comprises a source which emits a light in the wavelengths with respect to which the mask of the region 16 is transparent or semi-transparent, for example, a source of infrared light in the case of transparency with respect to infrared rays; and means for capturing the validation data which are able to capture the data under the light in question. In this manner, by the source and the capturing means being activated simultaneously, the validation data are acquired.

Securing the validation data according to the invention thus has the advantage of:

allowing the use of a conventional ink for the validation data, which ink is compatible with the ink jet printing units which are used by the ticket printers and therefore avoids any significant additional cost for printing those data;

completely concealing the presence of the validation data printed on the ticket, which further has an aesthetic advantage;

preventing the use of validation data which necessitate implementation of costly algorithms;

ensuring complete protection against any attempt to completely or partially duplicate the ticket using photocopiers or scanners which operate with white light.

Furthermore, using the infrared domain has the additional advantage that only a dedicated piece of equipment is capable of reading the validation data which are concealed below the layer of ink because the human eye is not sensitive to infrared rays.

In the embodiment described above, there is still a risk of fraud which is known by the term “micro-abrasion fraud” when the layer of ink according to the invention is produced in the form of a removable film.

When the validation data are protected by a removable layer, some fraudulent persons have no hesitation in removing tiny portions of the layer in multiple regions in order to cause the validation data to partially appear and thereby to reconstitute them.

That type of fraud requires minute examination of the secured data region in order to allow it to be revealed.

Similarly, some fraudulent persons have no hesitation in removing the layer, by micro-abrasion or other means, reading the validation data, then applying a new layer in order to reconstruct the secured data region in an identical manner.

In that instance again, extremely careful analysis is necessary in order to reveal such acts.

In accordance with a second embodiment of the invention, that type of problem is resolved by integrating the validation data directly within a removable film.

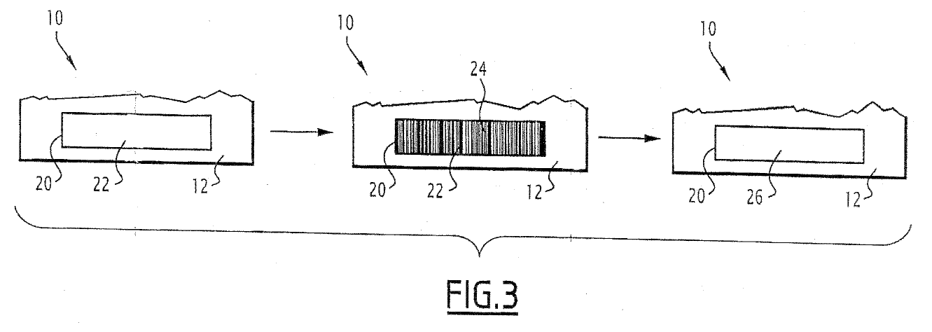

In FIG. 3, which illustrates the steps for producing a secured data region 20 in accordance with the second embodiment, at least one removable layer 22 of ink is printed on the face 12 of the gaming ticket 10.

Validation data 24, in this instance in the form of a bar code, are then printed on the surface of the removable layer 22.

Finally, one or more removable layers 26 of ink of the type described above, preferably of the type which is/are at least partially transparent with respect to infrared rays, are printed on the validation data in order to mask them.

It will therefore readily be understood that a fraudulent person who might attempt to remove the secured data region 20 would in the process damage the validation data, thereby preventing them from being read.

The integration of the validation data in a removable film therefore prevents any act of fraud by means of (micro) abrasion.

It should further be noted that this technique for integrating sensitive data in a removable film can also be used in the gaming region of the ticket. In some types of scratch-off game, one or more, but not all, of the removable regions must be removed in order to cause gaming patterns to appear.

In order to know whether the remaining non-removed regions have not been micro-abraded, validation data are integrated in the removable film in the same manner as that described above.

In this manner, reading by means of illumination with the appropriate light of the remaining non-removed regions by means of the above-described reader allows it to be established whether the validation data contained in the non-removed films are intact, and therefore to establish with certainty whether a fraudulent act has been carried out by means of (micro) abrasion.

The validation data are preferably constituted by patterns having a high spatial density, whilst having low redundancy.

Naturally, other embodiments are possible.

1. Gaming ticket comprising validation data which are printed on a face thereof and which are covered with at least one layer of ink which is opaque with respect to visible light, wherein the at least one layer of ink is at least partially transparent with respect to light having a wavelength different from that of visible light.

2. Ticket according to claim 1, wherein the at least one layer of ink is at least partially transparent with respect to light of infrared wavelength.

3. Ticket according to claim 1, wherein the validation data are integrated in a removable film.

4. Ticket according to claim 3, wherein the validation data are printed on a removable layer of ink of the face of the ticket, and the at least one layer of ink which is opaque with respect to visible light can be removed.

5. Optical reader for a gaming ticket, comprising means for capturing validation data which are printed on a face of a gaming ticket, wherein it comprises means for illuminating the face with light having a wavelength different from that of visible light in such a manner as to cause validation data, which are printed on the face and which are covered with a mask of ink which is at least partially transparent with respect to the light, to appear, and the capturing means are able to acquire the validation data under such light.

6. Optical reader according to claim 5, wherein the illumination means emit light of infrared wavelength.

7. Method for securing validation data of a gaming ticket, comprising a step for printing the validation data on a face of the gaming ticket, wherein it comprises a step for printing, on the validation data, at least one layer of ink which is opaque with respect to visible light and which is at least partially transparent with respect to light having a wavelength different from that of visible light.

8. Method for securing validation data of a gaming ticket according to claim 7, wherein the step for printing the validation data comprises:
a step for printing a first removable layer on the face of the gaming ticket; and
a step for printing the validation data on the first removable layer,
and the at least one layer of ink which is opaque with respect to visible light can be removed.

9. Method for reading validation data from a gaming ticket acquired according to the method of claim 7, wherein it comprises, at the same time as a step for capturing the validation data, a step for illuminating the face of the ticket with a light having a wavelength at which the at least one layer of ink is at least partially transparent.
